(19) United States
(12) Patent Application Publication
(10) Pub. No.: US 2024/0188540 A1
(43) Pub. Date: Jun. 13, 2024

(54) ELECTRONIC SYSTEM FOR MULTI-CHANNEL COMMUNICATION BASED REAL-TIME GEOLOCATION OF AN OBJECT

(71) Applicant: SAVE THIS LIFE, INC., Austin, TX (US)

(72) Inventor: Christian Robert White, Austin, TX (US)

(73) Assignee: SAVE THIS LIFE, INC., Austin, TX (US)

(21) Appl. No.: 18/286,713

(22) PCT Filed: Apr. 15, 2022
(86) PCT No.: PCT/US2022/024956

§ 371 Date: Oct. 12, 2023

Related U.S. Application Data
(60) Provisional application No. 63/175,713, filed on Apr. 16, 2021.

(51) Int. Cl. A01K 29/00; G06K 7/14; H04W 4/029

(52) U.S. Cl. CPC A01K 29/005; G06K 7/1413; G06K 7/1417; H04W 4/029

(57) ABSTRACT

Systems, methods, and apparatuses are provided for multi-channel communication based real-time geolocation of an object entity. The system is structured for dynamic location of an object and real-time notification transmission to an object owner. The system receives a first communication message associated with a first identification code from a first user device, and determines an object entity associated with the first identification code and the object tag component, based on analyzing the first communication message. Subsequently, typically, the system constructs an object location interface associated with the determined object entity, wherein the object attribute interface comprises a location display component associated with the captured geolocation parameter associated with the first user device. The system initiates presentation of the object location interface at the owner device associated with the object entity.

### CROSS-REFERENCE TO PRIORITY APPLICATION

This application claims priority to and the benefit of U.S. Provisional Patent Application Ser. No. 63/175,713, filed on Apr. 16, 2021, entitled “Electronic system for multi-channel communication based real-time geolocation of an object,” which is hereby incorporated by reference in its entirety.

### BACKGROUND

Current technology allows for identification systems that may identify object entities or animal subjects, such as pets, if they become lost. Typically, the pet may be microchipped and identified using that microchip. However, the availability of specific devices that are able to read the microchips is not widespread, thereby resulting in the inability to identify the lost pets and thereby precluding any subsequent mitigation actions such as reuniting the lost pet with its owner. Moreover, a person finding the lost pet may not have access to the internet at the time.

Therefore a need exists for a dynamic system structured for real-time location of an object and real-time notification transmission to an object owner, and multi-channel communication based real-time geolocation of an object.

### SUMMARY

The following presents a simplified summary of one or more embodiments in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments in a simplified form as a prelude to the more detailed description that is presented later.

Embodiments of the invention are directed to systems, methods, apparatuses and computer program products for multi-channel communication based real-time geolocation of an object entity or animal subject. The systems, methods, apparatuses and computer program products are structured for dynamic location of an object and real-time notification transmission to an object owner. The system/apparatus, in some embodiments, includes an object tag component, wherein the object tag is associated with a first identification code and structured for scanning and transmission of the first identification code, wherein the object tag is structured to be coupled with an associated object entity. The system/apparatus, in some embodiments, further includes at least one memory device with computer-readable program code stored thereon; at least one communication device; and at least one processing device operatively coupled to the at least one memory device and the at least one communication device. In some embodiments, executing the computer-readable program code is configured to cause the at least one processing device to: establish a first communication channel with a first user device; receive, via the first communication channel, a first communication message associated with the first identification code; determine the object entity associated with the first identification code and the object tag component, based on analyzing the first communication message; construct a first response message structured for the first communication channel, wherein the first response message comprises a user action component; in response to the first communication message, trigger transmission of the first response message, via the first communication channel, to the first user device, in real-time; construct an object attribute interface associated with the determined object entity, wherein the object attribute interface comprises (i) a display component associated with at least one attribute of the object entity, and (ii) a secure communication trigger action component structured for establishing operative communication between an owner device associated with the object entity and the first user device; in response to activation of the user action component of the first response message at the first user device, trigger a display overlay of the object attribute interface at a display device of the first user device, via a second communication channel; in response to determining activation of the secure communication trigger action component of the object attribute interface at the first user device: capture a geolocation parameter associated with the first user device; construct an object location interface associated with the determined object entity, wherein the object attribute interface comprises a location display component associated with the captured geolocation parameter associated with the first user device; and initiate presentation of the object location interface at the owner device associated with the object entity; and establish secure operative communication between the owner device associated with the object entity and the first user device without transmission of identifier parameters associated with at least the owner device associated with the object entity.

In some embodiments, and in combination with the above embodiment, the invention is structured for: receiving a first communication message associated with a first identification code from a first user device, wherein the first identification code is associated with an object tag component, wherein the object tag is structured to be coupled with an associated object entity; determining the object entity associated with the first identification code and the object tag component, based on analyzing the first communication message; in response to the first communication message, triggering transmission of a first response message to the first user device, in real-time, wherein the first response message comprises a user action component; in response to activation of the user action component of the first response message at the first user device, triggering a display overlay of an object attribute interface at a display device of the first user device, wherein the object attribute interface comprises a secure communication trigger action component structured for establishing operative communication between an owner device associated with the object entity and the first user device; and in response to determining activation of the secure communication trigger action component of the object attribute interface at the first user device: capturing a geolocation parameter associated with the first user device; constructing an object location interface associated with the determined object entity, wherein the object attribute interface comprises a location display component associated with the captured geolocation parameter associated with the first user device; and initiating presentation of the object location interface at the owner device associated with the object entity.

In some embodiments, and in combination with any of the above embodiments, the object entity is a pet animal, and wherein the object tag is attached to the pet animal such that the object tag is external to the pet animal.

In some embodiments, and in combination with any of the above embodiments, the object tag comprises a scannable element displayed on a first surface, wherein the scannable element is associated with the first identification code.

In some embodiments, and in combination with any of the above embodiments, wherein the scannable element comprises one or more of a textual element, a barcode, a QR code, and/or an image.

In some embodiments, and in combination with any of the above embodiments, the object tag is structured such that scanning the scannable element via the first user device is structured to initiate construction of the first communication message at a first communication channel application interface of the first user device, wherein constructing the first communication message comprises: adding text associated with the first identification code in a body of the first communication message; and/or adding a contact identifier parameter associated with an object entity identification database at a recipient field associated with the communication message, wherein the contact identifier parameter comprises a telephone number.

In some embodiments, and in combination with any of the above embodiments, the first communication message is received via a first communication channel, the first communication channel is a cellular telephone network communication channel, and the first communication message is selected from a group comprising a Short Message Service (SMS) type message, and a Multimedia Messaging Service (MMS) type message.

In some embodiments, and in combination with any of the above embodiments, the location display component associated with the captured geolocation parameter associated with the first user device comprises a map image indicating the captured geolocation parameter associated with the first user device within the map image.

In some embodiments, and in combination with any of the above embodiments, the invention is further configured for: determining, via the first user device, that a second communication channel is not active on the first user device; and in response to determining that the second communication channel is not active on the first user device, transmitting, via the first user device, the first communication message associated with the first identification code via a first communication channel.

In some embodiments, and in combination with any of the above embodiments, the invention is further configured for: in response to determining that a second communication channel is not active on the first user device, activating the second communication channel on the first user device; and triggering the display overlay of the object attribute interface at the display device of the first user device, via the second communication channel.

In some embodiments, and in combination with any of the above embodiments, the first communication message is received via a first communication channel, the first communication channel is a cellular telephone network communication channel, and the second communication channel is an internet communication channel.

In some embodiments, and in combination with any of the above embodiments, determining the object entity associated with the first identification code, further comprises determining one or attributes of the object entity comprising an image of the object entity, a name of the object entity, and/or a breed of the object entity.

In some embodiments, and in combination with any of the above embodiments, the invention is further configured for: in response to the first communication message, transmitting a preliminary object entity detection alert to the owner device associated with the object entity.

In some embodiments, and in combination with any of the above embodiments, the first response message is displayed at the first user device; wherein the user action component of the first response message is structured such that activation of the user action component automatically triggers the display overlay of the object attribute interface at the display device of the first user device; and wherein the user action component comprises at least one of a link, a hyperlink, hypertext, a URL, and/or anchor text.

In some embodiments, and in combination with any of the above embodiments, the invention is further configured for: constructing an object attribute interface associated with the determined object entity, wherein the object attribute interface comprises (i) a display component associated with at least one attribute of the object entity, and (ii) the secure communication trigger action component structured for establishing operative communication between an owner device associated with the object entity and the first user device; wherein the display component of the object attribute interface comprises an image of the object entity, a name of the object entity, and/or a breed of the object entity.

In some embodiments, and in combination with any of the above embodiments, the invention is further configured for: in response to determining activation of the secure communication trigger action component of the object attribute interface at the first user device, initiating presentation of a medical user input interface at the display device of the first user device; and receiving, via the medical user input interface, user input indicating whether the object entity requires medical attention; and wherein the object attribute interface further comprises the user input indicating whether the object entity requires medical attention.

In some embodiments, and in combination with any of the above embodiments, the invention is further configured for: capturing the geolocation parameter associated with the first user device comprises capturing a current GPS parameter of the first user device, and/or determining a location of the first user device based on triangulation of current cellular telephone network associated with the first user device.

In some embodiments, and in combination with any of the above embodiments, the invention is further configured for: presenting a navigation interface structured to route an object owner from a current location of the owner device to a location associated with the captured geolocation parameter associated with the first user device.

In some embodiments, and in combination with any of the above embodiments, the invention is further configured for: establishing secure operative communication between the owner device associated with the object entity and the first user device without transmission of identifier parameters associated with at least the owner device associated with the object entity; wherein establishing the secure operative communication between the owner device associated with the object entity and the first user device without transmission of identifier parameters associated with at least the owner device associated with the object entity, comprises establishing secure operative communication between the owner device associated with the object entity such (i) an object owner associated with the owner device and/or a user associated with the first user device are anonymous, and/or (ii) the user associated with the first user device cannot view contact information associated with the object owner.

In some embodiments, and in combination with any of the above embodiments, the first identification code associated with the object tag is associated with a microchip implanted into the object entity.

In some embodiments, and in combination with any of the above embodiments, the invention is further configured for: providing an object entity identification database having one or more object entity records stored therein, wherein each of the one or more object entity records are associated with an object entity; providing the first identification code such that the first identification code is associated with the object tag and the object entity; and creating a first object entity record of the one or more object entity records, wherein the first object entity record is associated with the first identification code, the object tag, the object entity, and/or identifier parameters associated with the owner device.

To the accomplishment of the foregoing and related ends, the one or more embodiments comprise the features hereinafter fully described and particularly pointed out in the claims. The following description and the annexed drawings set forth in detail certain illustrative features of the one or more embodiments. These features are indicative, however, of but a few of the various ways in which the principles of various embodiments may be employed, and this description is intended to include all such embodiments and their equivalents.

### BRIEF DESCRIPTION OF THE DRAWINGS

Having thus described embodiments of the invention in general terms, reference will now be made to the accompanying drawings, which are not necessarily drawn to scale, and wherein:

FIG. 1A illustrates a schematic representation 100A of a dynamic object location apparatus, system and environment, in accordance with embodiments of the present invention;

FIG. 1B illustrates a schematic representation 100B of the dynamic object location apparatus, system and environment of FIG. 1A, in accordance with embodiments of the present invention;

FIG. 2 illustrates a schematic representation 200 of a first user device of FIGS. 1A-1B, in accordance with embodiments of the present invention;

FIG. 3 illustrates a schematic representation 300 of an owner device of FIGS. 1A-1B, in accordance with embodiments of the present invention;

FIG. 4A illustrates a high-level process flow 400A for multi-channel communication based real-time geolocation of an object entity, in accordance with embodiments of the present invention;

FIG. 4B illustrates a high-level process flow 400B for multi-channel communication based real-time geolocation of an object entity, in accordance with embodiments of the present invention;

FIG. 5 illustrates a schematic representation 500 of a user interface at a first user device, in accordance with embodiments of the present invention;

FIG. 6 illustrates a schematic representation 600 of a user interface at a first user device, in accordance with embodiments of the present invention; and

FIG. 7 illustrates a schematic representation 700 of an object location interface at an owner device, in accordance with embodiments of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. In the following description, for purposes of explanation, numerous specific details are set forth in order to provide a thorough understanding of one or more embodiments. It may be evident; however, that such embodiment(s) may be practiced without these specific details. Like numbers refer to like elements throughout.

Various embodiments or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches may also be used.

The steps and/or actions of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some embodiments, the processor and the storage medium may reside in an Application Specific Integrated Circuit (ASIC). In the alternative, the processor and the storage medium may reside as discrete components in a computing device. Additionally, in some embodiments, the events and/or actions of a method or algorithm may reside as one or any combination or set of codes and/or instructions on a machine-readable medium and/or computer-readable medium, which may be incorporated into a computer program product.

In one or more embodiments, the functions described may be implemented in hardware, software, firmware, or any combination thereof. If implemented in software, the functions may be stored or transmitted as one or more instructions or code on a computer-readable medium. Computer-readable media includes both computer storage media and communication media including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures, and that can be accessed by a computer. Also, any connection may be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. “Disk” and “disc”, as used herein, include compact disc (CD), laser disc, optical disc, digital versatile disc (DVD), floppy disk and Blu-Ray disc where disks usually reproduce data magnetically, while discs usually reproduce data optically with lasers. Combinations of the above should also be included within the scope of computer-readable media.

The invention is directed to, in general, multi-channel communication based real-time geolocation of an object entity. The system is structured for dynamic location of an object and real-time notification transmission to an object owner. In this regard, the system receives a first communication message associated with a first identification code from a first user device, and determines an object entity associated with the first identification code and the object tag component, based on analyzing the first communication message. Subsequently, typically, the system constructs an object location interface associated with the determined object entity, wherein the object attribute interface comprises a location display component associated with the captured geolocation parameter associated with the first user device. The system initiates presentation of the object location interface at the owner device associated with the object entity. Moreover, the system is further structured to establish secure operative communication between the owner device associated with the object entity and the first user device without transmission of identifier parameters associated with at least the owner device associated with the object entity.

Typically, the term “object entity” or “animal subject” may refer to a pet animal, such as a canine animal, a feline animal, and/or the like. An object tag may be coupled with or attached to the pet animal, e.g., such that the object tag is external to the pet animal. The term “user” or “first user” may refer to an individual who has located a lost object entity or animal subject (e.g., a pet animal). The term “owner” or “object owner” may refer to an owner, caregiver, trained professional, trained/untrained guardian or another individual responsible for, or associated with, the object entity or animal subject (e.g., a pet animal), an owner or provider of the object tag, and/or the like. The object entity or animal subject (e.g., a pet animal) may refer to one or more animals, comprising mammals, amphibians, reptiles, birds, fishes, arthropods and other vertebrates and invertebrates. In some embodiments, the animal subject may refer to a domesticated animals comprising pets or companion animals, livestock, working animals, and the like. Although, dogs and cats may be more common pets, pet animals may also comprise rabbits, ferrets, rodents like gerbils and hamsters, avian pets such as parrots, pigeons and canaries, aquatic pets like fish, turtles and frogs, reptile and arthropod pets. Livestock animals and working animals may comprise cattle, goats, horses, deer, camels, sheep, poultry, and the like. In some embodiments, animal subject may refer to wild and non-domesticated animals. The animal subjects named above do not constitute an exhaustive list, but are provided for the purpose of illustration. Animal subjects, as referred to in this disclosure may typically comprise one or more non-human animals alluded to above and/or one or more animals not mentioned above.

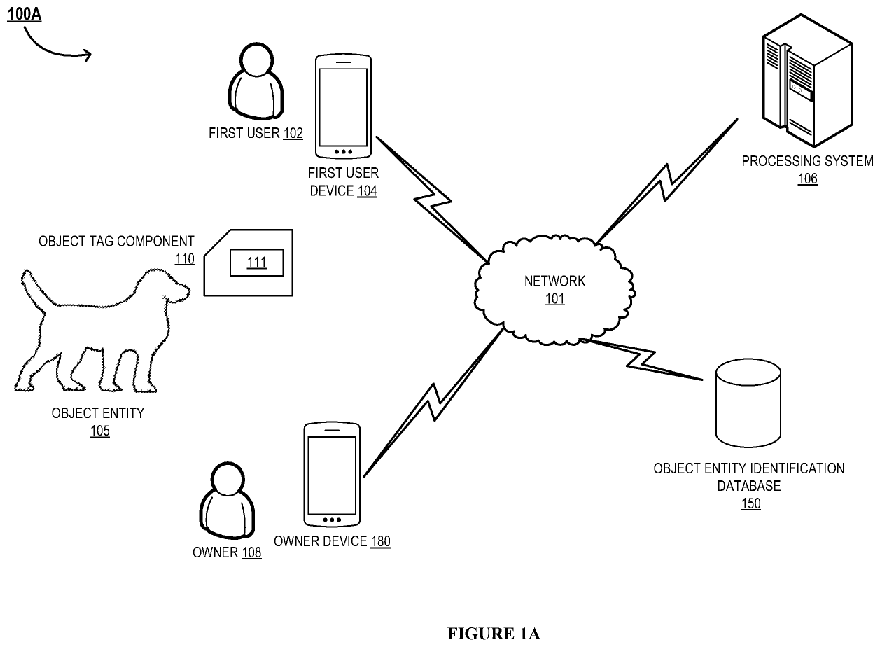

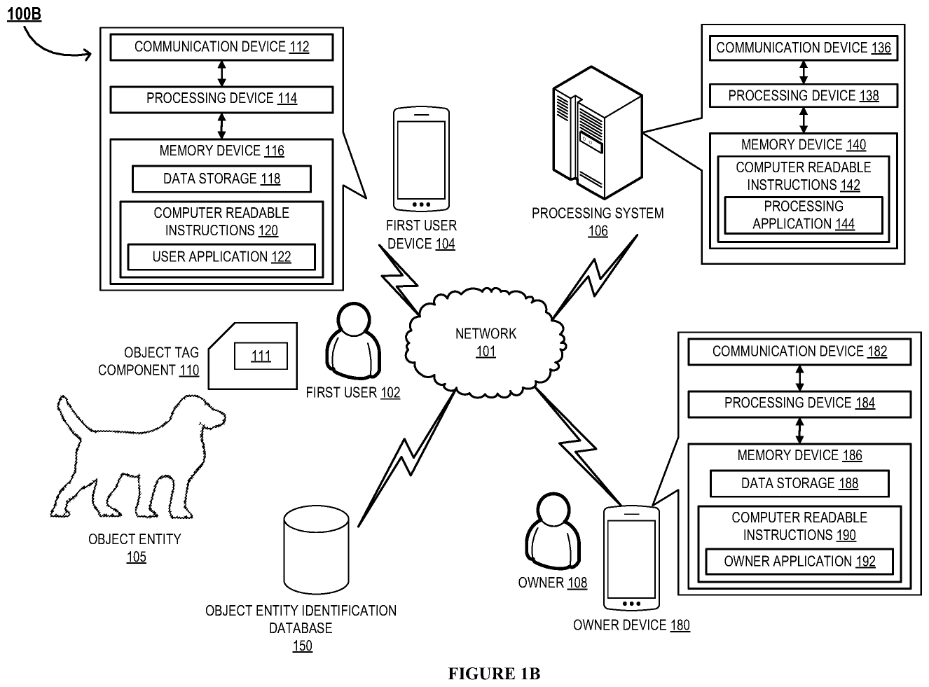

FIGS. 1A-1B illustrate schematic representations 100A and 100B of a dynamic object location apparatus, system and environment 100, in accordance with embodiments of the present invention. FIGS. 1A-1B provide a unique system that includes specialized devices, databases, servers and systems, communicably linked across a distributive network to perform the functions of dynamic location of an object and real-time notification transmission to an object owner. Systems, methods, and apparatuses are provided for multi-channel communication based real-time geolocation of an object entity. As illustrated in FIGS. 1A-1B, the processing system 106 or application server is operatively coupled, via a network 101 to a first user device 104 associated with a first user 102, to an owner device 180 associated with an owner/object owner 108, and an object entity identification database 150, and to one or more devices and systems not illustrated herein. In this way, the processing system 106 can send information to and receive information from the first user device 104, the owner device 180, the object entity identification database 150, etc. FIGS. 1A-1B illustrates only one example of an embodiment of the system environment 100, and it will be appreciated that in other embodiments one or more of the systems, devices, or servers may be combined into a single system, device, or server, or be made up of multiple systems, devices, or servers.

The network 101 may be a system specific distributive network receiving and distributing specific network signals and identifying specific network associated triggers. The network 101 may also be a global area network (GAN), such as the Internet, a wide area network (WAN), a local area network (LAN), or any other type of network or combination of networks. The network 101 may provide for wireline, wireless, or a combination wireline and wireless communication between devices on the network 101. In some embodiments, the network 101 is a cellular telephone network structured for transmission of communications/messages selected from a group comprising a Short Message Service (SMS) type message, and a Multimedia Messaging Service (MMS) type message. In some embodiments, the network 101 may enable communication between devices thorough near-field communication, transmission of electromagnetic waves, sound waves or any other suitable means. In some embodiments, the network 101 includes the internet. In some embodiments, the network 101 may include a wireless telephone network. Furthermore, the network 101 may comprise wireless communication networks to establish wireless communication channels such as a contactless communication channel and a near field communication (NFC) channel (for example, in the instances where communication channels are established between the user mobile device 104 and the second networked device 180b). In this regard, the wireless communication channel may further comprise near field communication (NFC), communication via radio waves, communication through the internet, communication via electromagnetic waves and the like.

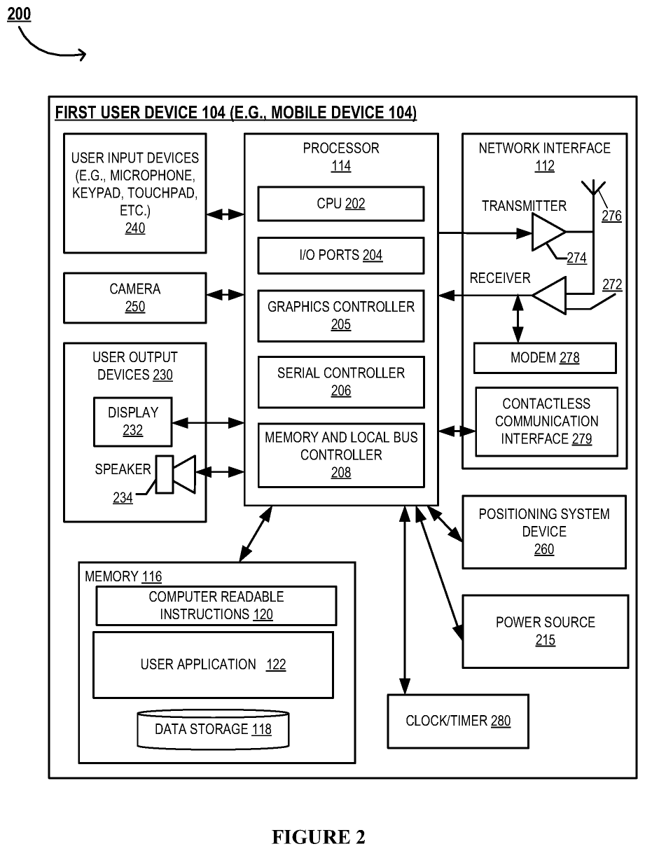

The first user 102 may refer to an individual who has located a lost object entity or animal subject (e.g., a pet animal). In some embodiments, the first user 102 is an individual that has a first user device 104, such as a mobile phone, tablet, or the like. The first user device 104 may be, for example, a desktop personal computer, a mobile system, such as a cellular phone, smart phone, personal data assistant (PDA), laptop, or the like. The first user device 104 generally comprises a communication device 112, a processing device 114, and a memory device 116. The first user device 104 may comprise other devices that are not illustrated, configured for location determination/navigation (GPS devices, accelerometers and the like), for authentication (fingerprint scanners, microphones, iris scanners and the like), for image capture (cameras, AR devices and the like), for display (screens, hologram projectors and the like), and other purposes, as will be described with respect to FIG. 2 later on. The first user device 104 is a computing system that enables the user to perform one or more user activities. The processing device 114 is operatively coupled to the communication device 112 and the memory device 116. The processing device 114 uses the communication device 112 to communicate with the network 101 and other devices on the network 101, such as, but not limited to the processing system 106. As such, the communication device 112 generally comprises a modem, server, or other device for communicating with other devices on the network 101. In some embodiments, the first user device 104 may comprise one or more user devices comprising mobile phones, tablets, smartphones, computers and wearable devices like smart watches, glasses, jewelry, fitness and activity monitors and the like.

The first user device 104 comprises computer-readable instructions 120 and data storage 118 stored in the memory device 116, which in one embodiment includes the computer-readable instructions 120 of a user application 122. In some embodiments first user device 104 may refer to multiple user devices that may be configured to communicate with the processing system 106 via the network 101. The user application 122 may be a standalone application configured for transmission and display of communications/messages, may refer to one or more existing applications on the user device, etc. In some embodiments the processing system 106 may transmit control signals to the first user device 104, configured to cause the user application 122 to perform one or more functions or steps associated with dynamic location of an object and real-time notification transmission to an object owner based on establishing communication links between network devices. The user 102 may communicate with the first user device 104 via audio communication, gesture-based communication, video communication, textual communication, biometric based communication, and/or the like.

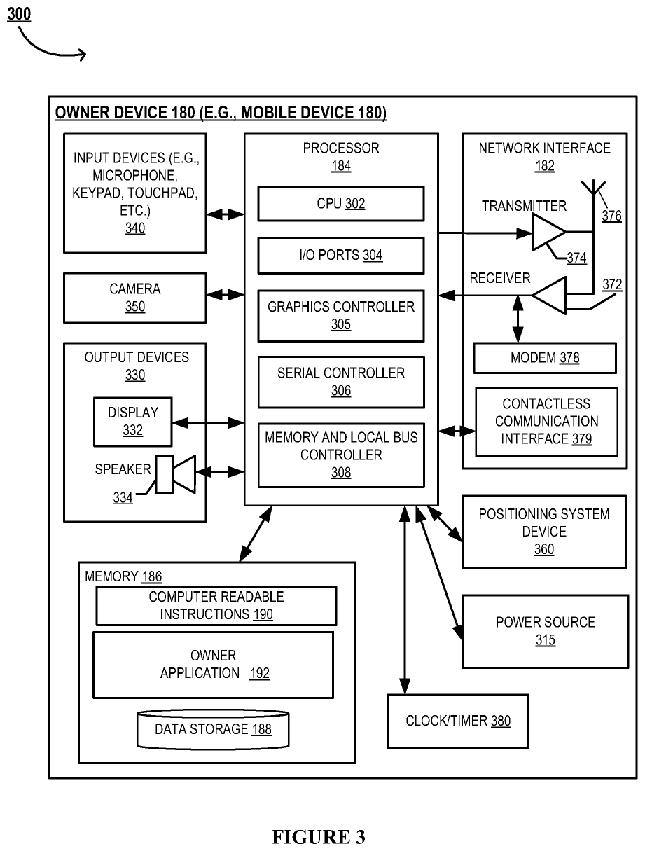

The object owner 108 may refer to an owner, caregiver, trained professional, trained/untrained guardian or another individual responsible for, or associated with, the object entity or animal subject (e.g., a pet animal), an owner or provider of the object tag 110, and/or the like. In some embodiments, the object owner 108 is an individual that has an owner device 180, such as a mobile phone, tablet, or the like. The owner device 180 may be, for example, a desktop personal computer, a mobile system, such as a cellular phone, smart phone, personal data assistant (PDA), laptop, or the like. The owner device 180 generally comprises a communication device 182, a processing device 184, and a memory device 186. The owner device 180 may comprise other devices that are not illustrated, configured for location determination/navigation (GPS devices, accelerometers and the like), for authentication (fingerprint scanners, microphones, iris scanners and the like), for image capture (cameras, AR devices and the like), for display (screens, hologram projectors and the like), and other purposes, as will be described with respect to FIG. 3 later on. The owner device 180 is a computing system that enables the object owner to perform one or more owner activities. The processing device 184 is operatively coupled to the communication device 182 and the memory device 186. The processing device 184 uses the communication device 182 to communicate with the network 101 and other devices on the network 101, such as, but not limited to the processing system 106. As such, the communication device 182 generally comprises a modem, server, or other device for communicating with other devices on the network 101. In some embodiments, the owner device 180 may comprise one or more owner devices comprising mobile phones, tablets, smartphones, computers and wearable devices like smart watches, glasses, jewelry, fitness and activity monitors and the like.

The owner device 180 comprises computer-readable instructions 190 and data storage 188 stored in the memory device 186, which in one embodiment includes the computer-readable instructions 190 of an owner application 192. In some embodiments owner device 180 may refer to multiple owner devices that may be configured to communicate with the processing system 106 via the network 101. The owner application 192 may be a standalone application configured for transmission and display of communications/messages, may refer to one or more existing applications on the owner device 180, etc. In some embodiments the processing system 106 may transmit control signals to the owner device 180, configured to cause the owner application 192 to perform one or more functions or steps associated with dynamic location of an object and real-time notification transmission to an object owner based on establishing communication links between network devices. The object owner 108 may communicate with the owner device 180 via audio communication, gesture-based communication, video communication, textual communication, biometric based communication, and/or the like.

The object entity/animal subject 105 may refer to a pet animal 105. An object tag 110 (also referred to as an object tag component 110) may be coupled with or attached to the pet animal 105, e.g., such that the object tag 110 is external to the pet animal 105. For example, the object tag 110 may be provided on a collar of the object entity 105. Typically, the object tag 110 is associated with a first identification code and structured for scanning and transmission of the first identification code. In some embodiments, the object tag 110 comprises a scannable element 111 displayed on a first surface. Typically, the scannable element 111 is associated with the first identification code. In some embodiments, the scannable element 111 comprises one or more of a textual element, a barcode, a QR code, and/or an image. That said, in some embodiments, the scannable element 111 may comprise an integrated circuit chip, an antenna, an RFID chip, and/or the like (not illustrated).

While only one processing system 106 is illustrated in FIGS. 1A-1B, it is understood that multiple network systems may make up the system environment 100. The processing system 106 generally comprises a communication device 136, a processing device 138, and a memory device 140. The processing system 106 comprises computer-readable instructions 142 stored in the memory device 140, which in one embodiment includes the computer-readable instructions 142 of a resource processing application 144. The processing system 106 may communicate with the object entity identification database 150 to determine/retrieve object owner information. The processing system 106 may communicate with the first user device 104 and the owner device 180 via secure connections generated for secure encrypted communications between the two systems for performing one or more steps described herein. In some embodiments, the secure connection may be an operative communication link/channel established via the network 101.

It is understood that the servers, systems, and devices described herein illustrate one embodiment of the invention. It is further understood that one or more of the servers, systems, and devices can be combined in other embodiments and still function in the same or similar way as the embodiments described herein.

FIG. 2 illustrates a schematic representation 200 of a first user device 104, in accordance with embodiments of the present invention. The first user device 104 may also be referred to as a “user mobile device” 104 may be any mobile communication device, such as a cellular telecommunications device (i.e., a cell phone or mobile phone), personal digital assistant (PDA), a mobile Internet accessing device, or another user mobile device including, but not limited to portable digital assistants (PDAs), pagers, mobile televisions, gaming devices, laptop computers, cameras, video recorders, audio/video player, radio, GPS devices, any combination of the aforementioned devices.

The user mobile device 104 may generally include a processing device or processor 114 communicably coupled to devices such as, a memory device 116, user output devices 230 (for example, a user display device 232, or a speaker 234), user input devices 240 (such as a microphone, keypad, touchpad, touch screen, and the like), a communication device or network interface device 112, a power source 215, a clock or other timer 280, a visual capture device such as a camera 250, a positioning system device 260, such as a geo-positioning system device like a GPS device, an accelerometer, and the like, one or more chips, and the like. The processor 114 may further include a central processing unit 202, input/output (I/O) port controllers 204, a graphics controller 205, a serial bus controller 206 and a memory and local bus controller 208.

The processor 114 may include functionality to operate one or more software programs or applications, which may be stored in the memory device 116. For example, the processor 114 may be capable of operating applications such as the user application 122. The user application 122 may then allow the user mobile device 104 to transmit and receive data and instructions from the processing system 106, web content, such as, for example, location-based content and/or other web page content, according to a Wireless Application Protocol (WAP), Hypertext Transfer Protocol (HTTP), and/or the like.

The processor 114 may be configured to use the network interface device 112 to communicate with one or more other devices on a network 101 such as, but not limited to the processing system 106. In this regard, the network interface device 112 may include an antenna 276 operatively coupled to a transmitter 274 and a receiver 272 (together a “transceiver”), modem 278 and a contactless communication interface 279. The processor 114 may be configured to provide signals to and receive signals from the transmitter 274 and receiver 272, respectively. The signals may include signaling information in accordance with the air interface standard of the applicable BLE standard, cellular system of the wireless telephone network and the like, that may be part of the network 101. In this regard, the user mobile device 104 may be configured to operate with one or more air interface standards, communication protocols, modulation types, and access types. By way of illustration, the user mobile device 104 may be configured to operate in accordance with any of a number of first, second, third, and/or fourth-generation communication protocols and/or the like. For example, the user mobile device 104 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols, and/or the like. The user mobile device 104 may also be configured to operate in accordance with non-cellular communication mechanisms, such as via a wireless local area network (WLAN) or other communication/data networks. The user mobile device 104 may also be configured to operate in accordance Bluetooth® low energy, audio frequency, ultrasound frequency, or other communication/data networks.

The network interface device 112 or communication device 112 may also include a user activity interface presented in user output devices 230 in order to allow a user 102 to execute some or all of processes described herein. The application interface may have access to the hardware, for example, the transceiver, and software previously described with respect to the network interface device 112. Furthermore, the application interface may have the ability to connect to and communicate with an external data storage on a separate system within the network 101. As described above, the user mobile device 104 includes a display device 232 having a user interface that includes user output devices 230 and/or user input devices 240. The user output devices 230 may include a display 232 (e.g., a liquid crystal display (LCD) or the like) and a speaker 234 or other audio device, which are operatively coupled to the processor 114. The user input devices 240, which may allow the user mobile device 104 to receive data from the user 102, may include any of a number of devices allowing the user mobile device 104 to receive data from a user 102, such as a keypad, keyboard, touch-screen, touchpad, microphone, mouse, joystick, other pointer device, button, soft key, and/or other input device(s).

The user mobile device 104 may further include a power source 215 (e.g., a rechargeable DC power source). Generally, the power source 215 is a device that supplies electrical energy to an electrical load. In some embodiment, power source 215 may convert a form of energy such as solar energy, chemical energy, mechanical energy, and the like, to electrical energy. Generally, the power source 215 in a user mobile device 104 may be a battery, such as a lithium battery, a nickel-metal hydride battery, or the like, that is used for powering various circuits, for example, the transceiver circuit, and other devices that are used to operate the user mobile device 104. Alternatively, the power source 215 may be a power adapter that can connect a power supply from a power outlet to the user mobile device 104. In such embodiments, a power adapter may be classified as a power source “in” the user mobile device 104.

As discussed previously, the first user device 104 comprises computer-readable instructions 120 and data storage 118 stored in the memory device 116, which in one embodiment includes the computer-readable instructions 120 of a user application 122. The user mobile device 104 may also include a memory buffer, cache memory or temporary memory device operatively coupled to the processor 114. Typically, one or more applications such as the user application 122, are loaded into the temporarily memory during use. As used herein, memory may include any computer readable medium configured to store data, code, or other information. The memory device 116 may include volatile memory, such as volatile Random-Access Memory (RAM) including a cache area for the temporary storage of data. The memory device 116 may also include non-volatile memory, which can be embedded and/or may be removable. The non-volatile memory may additionally or alternatively include an electrically erasable programmable read-only memory (EEPROM), flash memory or the like.

In some instances, the user mobile device 104 comprises sensor devices 240 comprising biometric sensors for capturing parameters associated with the user. These biometric sensors 240 are configured to retrieve, receive, analyze and or validate biometric credentials associated with the user. In this regard, the biometric sensors 240 may comprise optical sensors, ultrasonic sensors, and/or capacitance sensors. The biometric sensors may further comprise radio frequency, thermal, pressure, piezo-resistive/piezoelectric, microelectromechanical sensors, and the like.

FIG. 3 illustrates a schematic representation 300 of an owner device 180, in accordance with embodiments of the present invention. The owner device 180 may be any mobile communication device, such as a cellular telecommunications device (i.e., a cell phone or mobile phone), personal digital assistant (PDA), a mobile Internet accessing device, or another owner device 180 including, but not limited to portable digital assistants (PDAs), pagers, mobile televisions, gaming devices, laptop computers, cameras, video recorders, audio/video player, radio, GPS devices, any combination of the aforementioned devices.

The owner device 180 may generally include a processing device or processor 184 communicably coupled to devices such as, a memory device 186, output devices 330 (for example, a display device 332, or a speaker 334), input devices 340 (such as a microphone, keypad, touchpad, touch screen, and the like), a communication device or network interface device 182, a power source 315, a clock or other timer 380, a visual capture device such as a camera 350, a positioning system device 360, such as a geo-positioning system device like a GPS device, an accelerometer, and the like, one or more chips, and the like. The processor 184 may further include a central processing unit 302, input/output (I/O) port controllers 304, a graphics controller 305, a serial bus controller 306 and a memory and local bus controller 308.

The processor 184 may include functionality to operate one or more software programs or applications, which may be stored in the memory device 186. For example, the processor 184 may be capable of operating applications such as the owner application 192. The owner application 192 may then allow the owner device 180 to transmit and receive data and instructions from the processing system 106, web content, such as, for example, location-based content and/or other web page content, according to a Wireless Application Protocol (WAP), Hypertext Transfer Protocol (HTTP), and/or the like.

The processor 184 may be configured to use the network interface device 182 to communicate with one or more other devices on a network 101 such as, but not limited to the processing system 106. In this regard, the network interface device 182 may include an antenna 376 operatively coupled to a transmitter 374 and a receiver 372 (together a “transceiver”), modem 378 and a contactless communication interface 379. The processor 184 may be configured to provide signals to and receive signals from the transmitter 374 and receiver 372, respectively. The signals may include signaling information in accordance with the air interface standard of the applicable BLE standard, cellular system of the wireless telephone network and the like, that may be part of the network 101. In this regard, the owner device 180 may be configured to operate with one or more air interface standards, communication protocols, modulation types, and access types. By way of illustration, the owner device 180 may be configured to operate in accordance with any of a number of first, second, third, and/or fourth-generation communication protocols and/or the like. For example, the owner device 180 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols, and/or the like. The owner device 180 may also be configured to operate in accordance with non-cellular communication mechanisms, such as via a wireless local area network (WLAN) or other communication/data networks. The owner device 180 may also be configured to operate in accordance Bluetooth® low energy, audio frequency, ultrasound frequency, or other communication/data networks.

The network interface device 182 or communication device 182 may also include an activity interface presented in output devices 330 in order to allow the owner 108 to execute some or all of processes described herein. The application interface may have access to the hardware, for example, the transceiver, and software previously described with respect to the network interface device 182. Furthermore, the application interface may have the ability to connect to and communicate with an external data storage on a separate system within the network 101. As described above, the owner device 180 includes a display device 332 having an interface that includes output devices 330 and/or input devices 340. The output devices 330 may include a display 332 (e.g., a liquid crystal display (LCD) or the like) and a speaker 334 or other audio device, which are operatively coupled to the processor 184. The input devices 340, which may allow the owner device 180 to receive data from the owner 108, may include any of a number of devices allowing the owner device 180 to receive data from the owner 108, such as a keypad, keyboard, touch-screen, touchpad, microphone, mouse, joystick, other pointer device, button, soft key, and/or other input device(s).

The owner device 180 may further include a power source 315 (e.g., a rechargeable DC power source). Generally, the power source 315 is a device that supplies electrical energy to an electrical load. In some embodiment, power source 315 may convert a form of energy such as solar energy, chemical energy, mechanical energy, and the like, to electrical energy. Generally, the power source 315 in an owner device 180 may be a battery, such as a lithium battery, a nickel-metal hydride battery, or the like, that is used for powering various circuits, for example, the transceiver circuit, and other devices that are used to operate the owner device 180. Alternatively, the power source 315 may be a power adapter that can connect a power supply from a power outlet to the owner device 180. In such embodiments, a power adapter may be classified as a power source “in” the owner device 180.

As discussed previously, the owner device 180 comprises computer-readable instructions 190 and data storage 188 stored in the memory device 186, which in one embodiment includes the computer-readable instructions 190 of an owner application 192. The owner device 180 may also include a memory buffer, cache memory or temporary memory device operatively coupled to the processor 184. Typically, one or more applications such as the owner application 192, are loaded into the temporarily memory during use. As used herein, memory may include any computer readable medium configured to store data, code, or other information. The memory device 186 may include volatile memory, such as volatile Random-Access Memory (RAM) including a cache area for the temporary storage of data. The memory device 186 may also include non-volatile memory, which can be embedded and/or may be removable. The non-volatile memory may additionally or alternatively include an electrically erasable programmable read-only memory (EEPROM), flash memory or the like.

In some instances, the owner device 180 comprises sensor devices 340 comprising biometric sensors for capturing parameters associated with the owner 108. These biometric sensors 340 are configured to retrieve, receive, analyze and or validate biometric credentials associated with the owner 108. In this regard, the biometric sensors 340 may comprise optical sensors, ultrasonic sensors, and/or capacitance sensors. The biometric sensors may further comprise radio frequency, thermal, pressure, piezo-resistive/piezoelectric, microelectromechanical sensors, and the like.

In some instances, various features and functions of the invention are described herein with respect to a “system.” In some embodiments, the system may refer to the processing system 106 performing one or more steps described herein in conjunction with other devices and systems, either automatically based on executing computer readable instructions 142 of the memory device 140. In some instances, the system refers to the devices and systems on the network environment 100 of FIGS. 1A-1B. The features and functions of various embodiments of the invention are be described below in further detail.

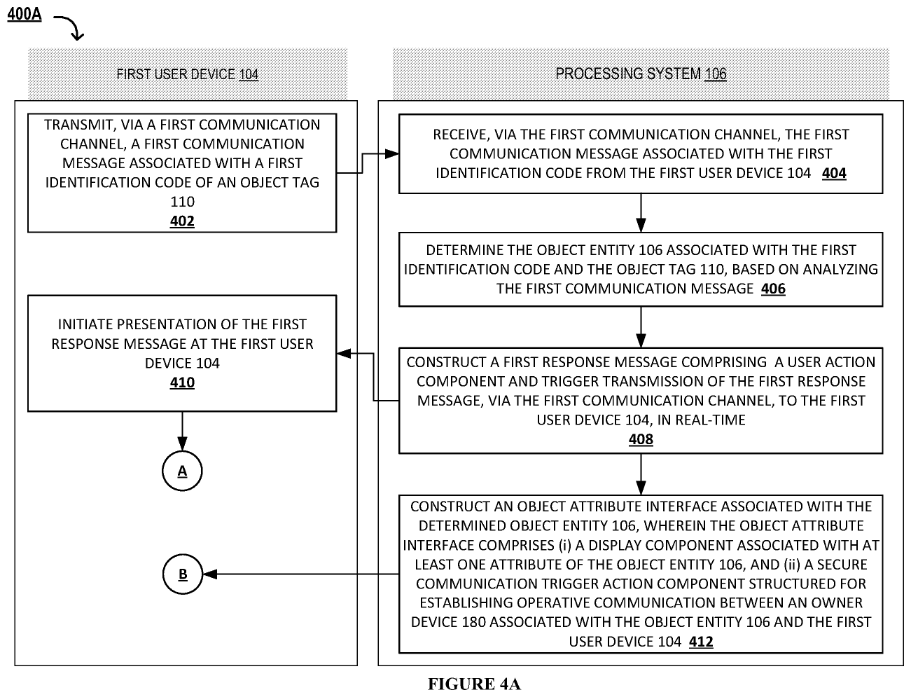

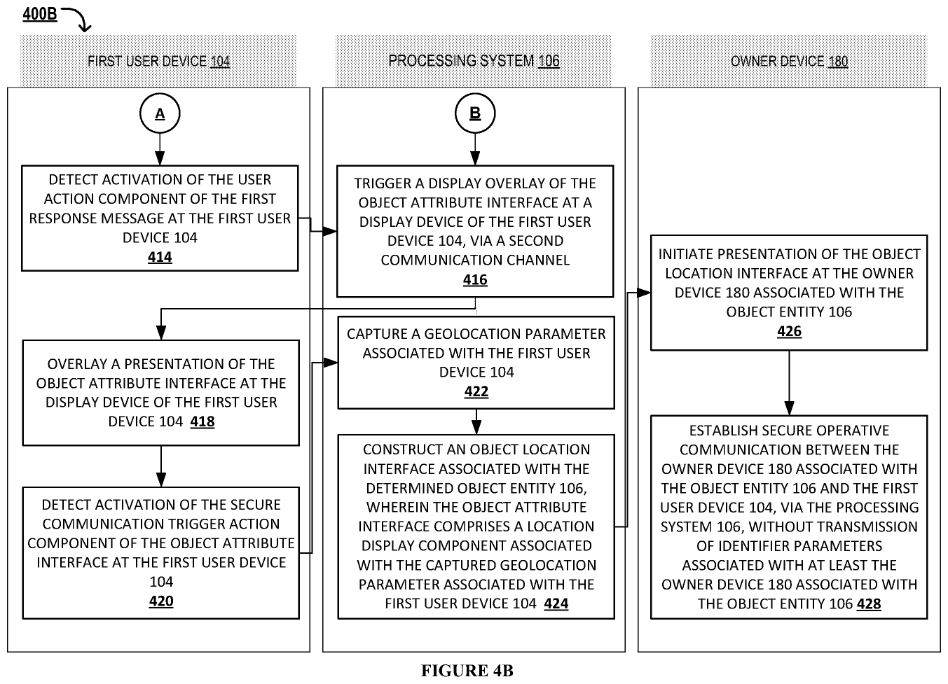

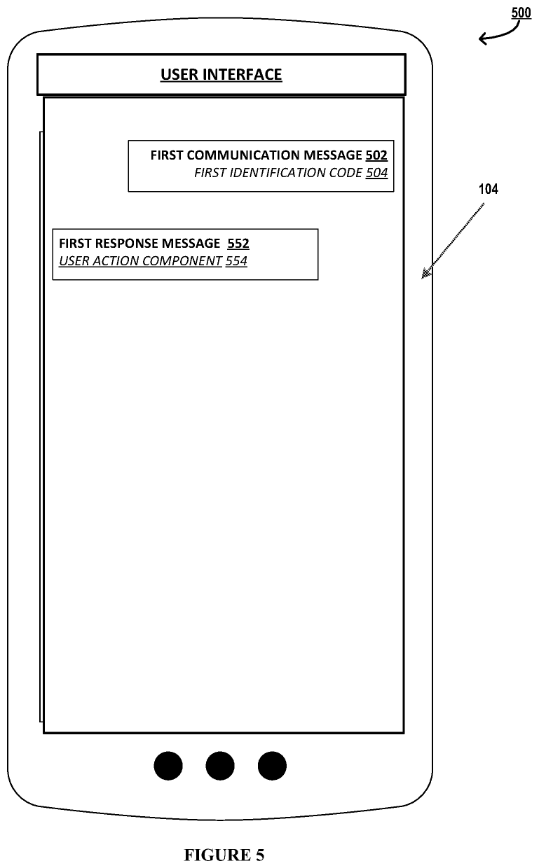

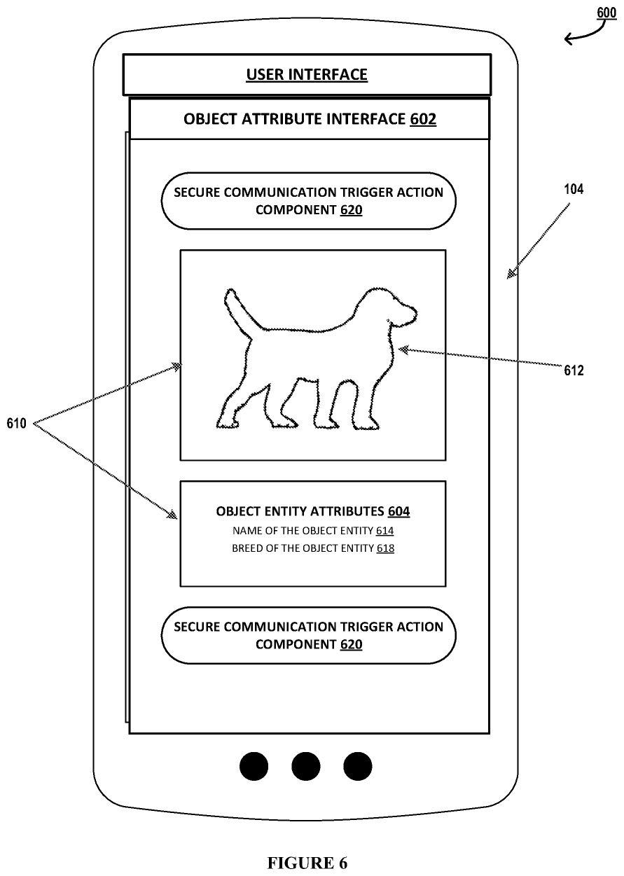

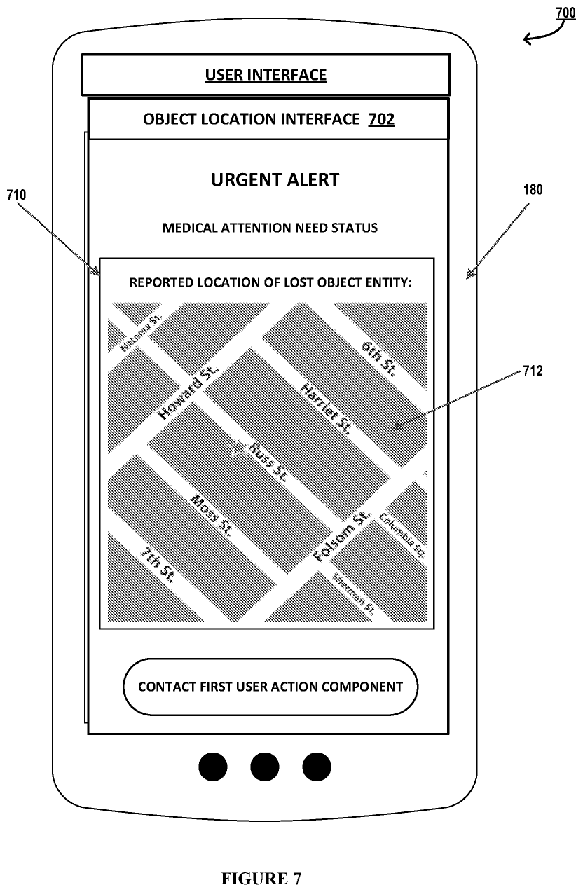

Referring now to FIGS. 4A-4B, illustrating a high-level process flows 400A-400B for multi-channel communication based real-time geolocation of an object entity. The process flow involves dynamic location of an object and real-time notification transmission to an object owner. In some embodiments, some or all of the steps of the process flows 400A-400B are performed by the processing system 106, e.g., based on causing the first user device 104, the owner device 180, and/or object entity identification database 150, to perform certain functions. In some embodiments, the “system” as used with respect to the steps 402-428 herein may refer to the processing system 106. Moreover, the high-level process flows 400A-400B are described in conjunction with FIGS. 5-8. FIG. 5 illustrates a schematic representation 500 of a user interface at a first user device, in accordance with embodiments of the present invention. FIG. 6 illustrates a schematic representation 600 of a user interface at a first user device, in accordance with embodiments of the present invention. FIG. 7 illustrates a schematic representation 700 of an object location interface at an owner device, in accordance with embodiments of the present invention.

The system is configured to construct, maintain, parse, operate, and analyze the object entity identification database 150. Here, the system may provide an object entity identification database 150 having one or more object entity records stored therein. Each of the one or more object entity records are associated with an object entity. The system may provide the first identification code 504 such that the first identification code 504 is associated with the object tag 110 and the object entity 105. The system may create/construct a first object entity record of the one or more object entity records. Here, the first object entity record is associated with the first identification code 504, the object tag 110, the object entity 105, and/or identifier parameters associated with the owner device 180.

The process flow 400A begins with the first user 102 locating a lost object entity 105 or animal subject (e.g., a pet animal). As described previously, the object entity 105 may comprise/coupled with an object tag 110. Typically, the object tag 110 is associated with a first identification code 504 and structured for scanning and transmission of the first identification code 504. Moreover, the object tag 110 is typically attached to the pet animal such that the object tag 110 is external to the pet animal, e.g., at a collar of the pet animal. In some embodiments, the object tag 110 comprises a scannable element 111 displayed on a first surface. Here, the scannable element 111 is associated with the first identification code 504, and may comprise one or more of a textual element, a barcode, a QR code, and/or an image. That said, it is contemplated that the first identification code 504 may be associated with a microchip implanted into the object entity 105.

The first user 102 may study the object tag 110 and its scannable element 111. In some embodiments, the user may scan the object tag 110 and its scannable element 111 using first user device 104, such as a mobile phone, tablet, or the like. Either the system may automatically construct a first communication message 502 associated with the first identification code 504 (illustrated in FIG. 5) associated with an object tag 110, or the first user 102 may manually construct the first communication message 502 associated with the first identification code 504 (illustrated in FIG. 5) associated with an object tag 110.

In some embodiments, the object tag 110 is structured such that scanning the scannable element 111 via the first user device 104 is structured to initiate construction of the first communication message 502 at a first communication channel application interface of the first user device 104. To construct the first communication message 502, the system may add text associated with the first identification code 504 in a body of the first communication message 502, and/or add a contact identifier parameter associated with an object entity identification database 150 at a recipient field associated with the communication message, wherein the contact identifier parameter comprises a telephone number. In some embodiments, the system customized/adapts the first communication message 502 to the first communication channel.

In some embodiments, the first communication channel may be a default channel, while in other embodiments, the system may automatically switch to the first communication channel in response to determining that another second communication channel (e.g., internet communication) is unavailable. For instance, the system may determine that a second communication channel is not active on the first user device 104. In response to determining that the second communication channel is not active on the first user device 104, the system may transmit the first communication message 502 associated with the first identification code 504 via the first communication channel. As a non-limiting example, the first communication channel maybe a cellular telephone network communication channel, and the second communication channel maybe an internet communication channel.

In some embodiments, the first communication channel is a cellular telephone network communication channel. Here, the first communication message 502 is selected from a group comprising a Short Message Service (SMS) type message, and a Multimedia Messaging Service (MMS) type message.

As illustrated by block 402, the first user device 104 may transmit the constructed first communication message 502 to the processing system, via a first communication channel. Here, the system may establish a first communication channel with a first user device 104.

Next, at block 404, the system may receive, via the first communication channel, a first communication message 502 associated with the first identification code 504 associated with an object tag 110 from the first user device 104. The system may then determine the object entity 105 associated with the first identification code 504 and the object tag 110, based on analyzing the first communication message 502, as indicated by block 406. Moreover, the system may determine one or attributes of the object entity 105 comprising an image of the object entity 612, a name of the object entity 614, and/or a breed of the object entity 618. In some embodiments, in response to the first communication message 502, transmit a preliminary object entity detection alert to the owner device 180 associated with the object entity 105.

At block 408, the system may construct a first response message 552 structured for the first communication channel. The first response message 552 is illustrated in FIG. 5. In some embodiments, the first response message 552 comprises a user action component 554, as illustrated in FIG. 5. Here, the user action component 554 may be at least one of a link, a hyperlink, hypertext, a URL, and/or anchor text. In response to the first communication message 502, the system may trigger transmission of the first response message 552, via the first communication channel, to the first user device 104, in real-time.

Here, as indicated by block 410, the system may initiate presentation of the first response message 552 at the first user device 104, as illustrated in FIG. 5. In some embodiments, the user action component 554 of the first response message 552 is structured such that activation of the user action component 554 automatically triggers the display overlay of the object attribute interface 602 at the display device of the first user device 104.

At block 412, the system may construct an object attribute interface 602 associated with the determined object entity 105. In some embodiments, the object attribute interface 602 comprises (i) a display component 610 associated with at least one attribute of the object entity 105, and (ii) a secure communication trigger action component 620 structured for establishing operative communication between an owner device 180 associated with the object entity 105 and the first user device 104, as illustrated in FIG. 6. As illustrated in FIG. 6, in some embodiments, the display component 610 of the object attribute interface 602 comprises an image of the object entity 612, a name of the object entity 614, and/or a breed of the object entity 618.

The system may then detect activation of the user action component of the first response message at the first user device 104, as indicated by block 414. In some embodiments, the system may initiate presentation of a medical user input interface at the display device of the first user device 104. The system may subsequently receive via the medical user input interface, user input indicating whether the object entity 105 requires medical attention. The system may also include the user input indicating whether the object entity 105 requires medical attention in the object attribute interface 602.

Next, at block 416, the system may, in response to activation of the user action component 554 of the first response message 552 at the first user device 104, trigger a display overlay of the object attribute interface 602 at a display device of the first user device 104, via a second communication channel, as illustrated in FIG. 6. In some embodiments, the second communication channel may be a default channel, while in other embodiments, the system may automatically activate the second communication channel. For instance, in response to determining that the second communication channel is not active on the first user device 104, the system may activate the second communication channel on the first user device 104. As a non-limiting example, the first communication channel maybe a cellular telephone network communication channel, and the second communication channel maybe an internet communication channel.

As indicated by block 418, the system may overlay a presentation of the object attribute interface 602 at the display device of the first user device 104, as illustrated in FIG. 6. In some embodiments, the object attribute interface 602 may comprise via one or more graphical control elements, buttons, toggle bars, scroll bars, lists, text boxes, links, and the like provided on the user interface of the user application. Moreover, at block 420, the system may detect activation of the secure communications trigger action component of the object attribute interface at the first user device 104.

Next, at block 422, in response to determining activation of the secure communication trigger action component 620 of the object attribute interface 602 at the first user device 104, the system may capture a geolocation parameter associated with the first user device 104. In this regard, the system may capture a current GPS parameter of the first user device 104, and/or determine a location of the first user device 104 based on triangulation of current cellular telephone network associated with the first user device 104.

The system may then construct an object location interface 702 associated with the determined object entity 105, at block 424. Typically, the object attribute interface 602 comprises a location display component 710 associated with the captured geolocation parameter associated with the first user device 104, as illustrated in FIG. 7. In some embodiments, the location display component 710 associated with the captured geolocation parameter associated with the first user device 104 comprises a map image 712 indicating the captured geolocation parameter associated with the first user device 104 within the map image 712. Next, at block 426, the system may initiate presentation of the object location interface 702 at the owner device 180 associated with the object entity 105. In some embodiments, the system may present a navigation interface structured to route an object owner 108 from a current location of the owner device 180 to a location associated with the captured geolocation parameter associated with the first user device 104. In some embodiments, the object location interface 702 may comprise via one or more graphical control elements, buttons, toggle bars, scroll bars, lists, text boxes, links, and the like provided on the user interface of the user application.

Next, at block 428, the system may establish secure operative communication between the owner device 180 associated with the object entity 105 and the first user device 104 without transmission of identifier parameters associated with at least the owner device 180 associated with the object entity 105. Here, establishing the secure operative communication between the owner device 180 associated with the object entity 105 and the first user device 104 comprises establishing secure operative communication between the owner device 180 associated with the object entity 105 such (i) an object owner 108 associated with the owner device 180 and/or a user associated with the first user device 104 are anonymous, and/or (ii) the user associated with the first user device 104 cannot view contact information associated with the object owner 108.

The steps and/or actions of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some embodiments, the processor and the storage medium may reside in an Application Specific Integrated Circuit (ASIC). In the alternative, the processor and the storage medium may reside as discrete components in a computing device. Additionally, in some embodiments, the events and/or actions of a method or algorithm may reside as one or any combination or set of codes and/or instructions on a machine-readable medium and/or computer-readable medium, which may be incorporated into a computer program product.

In one or more embodiments, the functions described may be implemented in hardware, software, firmware, or any combination thereof. If implemented in software, the functions may be stored or transmitted as one or more instructions or code on a computer-readable medium. Computer-readable media includes both computer storage media and communication media including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures, and that can be accessed by a computer. Also, any connection may be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. “Disk” and “disc”, as used herein, include compact disc (CD), laser disc, optical disc, digital versatile disc (DVD), floppy disk and Blu-Ray disc where disks usually reproduce data magnetically, while discs usually reproduce data optically with lasers. Combinations of the above should also be included within the scope of computer-readable media.

As will be appreciated by one of skill in the art in view of this disclosure, embodiments of the invention may be embodied as an apparatus (e.g., a system, computer program product, and/or other device), a method, or a combination of the foregoing. Accordingly, embodiments of the invention may take the form of an entirely hardware embodiment, an entirely software embodiment (including firmware, resident software, micro-code, etc.), or an embodiment combining software and hardware aspects that may generally be referred to herein as a “system.” Furthermore, embodiments of the invention may take the form of a computer program product comprising a computer-usable storage medium having computer-usable program code/computer-readable instructions embodied in the medium.

Any suitable computer-usable or computer-readable medium may be utilized. The computer usable or computer readable medium may be, for example but not limited to, an electronic, magnetic, optical, electromagnetic, infrared, or semiconductor system, apparatus, or device. More specific examples (a non-exhaustive list) of the computer-readable medium would include the following: an electrical connection having one or more wires; a tangible medium such as a portable computer diskette, a hard disk, a random access memory (RAM), a read-only memory (ROM), an erasable programmable read-only memory (EPROM or Flash memory), a compact disc read-only memory (CD-ROM), or other tangible optical or magnetic storage device.

Computer program code/computer-readable instructions for carrying out operations of embodiments of the invention may be written in an object oriented, scripted or unscripted programming language such as Java, Pearl, Smalltalk, C++ or the like. However, the computer program code/computer-readable instructions for carrying out operations of the invention may also be written in conventional procedural programming languages, such as the “C” programming language or similar programming languages.

Embodiments of the invention described above, with reference to flowchart illustrations and/or block diagrams of methods or apparatuses/systems (the term “apparatus” including systems and computer program products), will be understood to include that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a particular machine, such that the instructions, which execute via the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer readable memory produce an article of manufacture including instructions, which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions, which execute on the computer or other programmable apparatus, provide steps for implementing the functions/acts specified in the flowchart and/or block diagram block or blocks. Alternatively, computer program implemented steps or acts may be combined with operator or human implemented steps or acts in order to carry out an embodiment of the invention.

Specific embodiments of the invention are described herein. Many modifications and other embodiments of the invention set forth herein will come to mind to one skilled in the art to which the invention pertains, having the benefit of the teachings presented in the foregoing descriptions and the associated drawings. Therefore, it is to be understood that the invention is not to be limited to the specific embodiments disclosed and that modifications and other embodiments and combinations of embodiments are intended to be included within the scope of the appended claims. Although specific terms are employed herein, they are used in a generic and descriptive sense only and not for purposes of limitation.

While the foregoing disclosure discusses illustrative embodiments, it should be noted that various changes and modifications could be made herein without departing from the scope of the described aspects and/or embodiments as defined by the appended claims. Furthermore, although elements of the described aspects and/or embodiments may be described or claimed in the singular, the plural is contemplated unless limitation to the singular is explicitly stated. Additionally, all or a portion of any embodiment may be utilized with all or a portion of any other embodiment, unless stated otherwise.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

1. An apparatus configured for multi-channel communication based real-time geolocation of an object entity, wherein the apparatus is structured for dynamic location of an object and real-time notification transmission to an object owner, the apparatus comprising:
an object tag component, wherein the object tag is associated with a first identification code and structured for scanning and transmission of the first identification code, wherein the object tag is structured to be coupled with an associated object entity;
at least one memory device with computer-readable program code stored thereon;
at least one communication device;
at least one processing device operatively coupled to the at least one memory device and the at least one communication device, wherein executing the computer-readable program code is configured to cause the at least one processing device to:
establish a first communication channel with a first user device;
receive, via the first communication channel, a first communication message associated with the first identification code from the first user device;
determine the object entity associated with the first identification code and the object tag component, based on analyzing the first communication message;
construct a first response message structured for the first communication channel, wherein the first response message comprises a user action component;
in response to the first communication message, trigger transmission of the first response message, via the first communication channel, to the first user device, in real-time;
construct an object attribute interface associated with the determined object entity, wherein the object attribute interface comprises (i) a display component associated with at least one attribute of the object entity, and (ii) a secure communication trigger action component structured for establishing operative communication between an owner device associated with the object entity and the first user device;
in response to activation of the user action component of the first response message at the first user device, trigger a display overlay of the object attribute interface at a display device of the first user device, via a second communication channel;
in response to determining activation of the secure communication trigger action component of the object attribute interface at the first user device:
capture a geolocation parameter associated with the first user device;
construct an object location interface associated with the determined object entity, wherein the object attribute interface comprises a location display component associated with the captured geolocation parameter associated with the first user device; and
initiate presentation of the object location interface at the owner device associated with the object entity; and
establish secure operative communication between the owner device associated with the object entity and the first user device without transmission of identifier parameters associated with at least the owner device associated with the object entity.

2. (canceled)

3. The apparatus of claim 1, wherein the object tag comprises a scannable element displayed on a first surface, wherein the scannable element is associated with the first identification code, wherein the object entity is a pet animal, and wherein the object tag is attached to the pet animal such that the object tag is external to the pet animal.

4. The apparatus of claim 3, wherein the scannable element comprises one or more of a textual element, a barcode, a QR code, and/or an image.

5. The apparatus of claim 3, wherein the object tag is structured such that scanning the scannable element via the first user device is structured to initiate construction of the first communication message at a first communication channel application interface of the first user device, wherein constructing the first communication message comprises:
adding text associated with the first identification code in a body of the first communication message; and/or
adding a contact identifier parameter associated with an object entity identification database at a recipient field associated with the communication message, wherein the contact identifier parameter comprises a telephone number.

6. (canceled)

7. The apparatus of claim 1, wherein the location display component associated with the captured geolocation parameter associated with the first user device comprises a map image indicating the captured geolocation parameter associated with the first user device within the map image.

8. The apparatus of claim 1, wherein executing the computer-readable program code is configured to further cause the at least one processing device to, via the first user device:
determine that a second communication channel is not active on the first user device; and
in response to determining that the second communication channel is not active on the first user device, transmit the first communication message associated with the first identification code via the first communication channel.

9. The apparatus of claim 1, wherein executing the computer-readable program code is configured to further cause the at least one processing device to, via the first user device:
in response to determining that the second communication channel is not active on the first user device, activate the second communication channel on the first user device; and
trigger the display overlay of the object attribute interface at the display device of the first user device, via the second communication channel.

10. (canceled)

11. The apparatus of claim 1, wherein determining the object entity associated with the first identification code, further comprises determining one or attributes of the object entity comprising an image of the object entity, a name of the object entity, and/or a breed of the object entity.

12. (canceled)

13. The apparatus of claim 1, wherein the first response message is displayed at the first user device; wherein the user action component of the first response message is structured such that activation of the user action component automatically triggers the display overlay of the object attribute interface at the display device of the first user device; and wherein the user action component comprises at least one of a link, a hyperlink, hypertext, a URL, and/or anchor text.

14. The apparatus of claim 1, wherein the display component of the object attribute interface comprises an image of the object entity, a name of the object entity, and/or a breed of the object entity, wherein the display component associated with the at least one attribute of the object entity comprises an image of the object entity.

15. The apparatus of claim 1, wherein executing the computer-readable program code is configured to further cause the at least one processing device to:
in response to determining activation of the secure communication trigger action component of the object attribute interface at the first user device, initiate presentation of a medical user input interface at the display device of the first user device; and
receive, via the medical user input interface, user input indicating whether the object entity requires medical attention; and
wherein the object attribute interface further comprises the user input indicating whether the object entity requires medical attention.

16. The apparatus of claim 1, wherein capturing the geolocation parameter associated with the first user device comprises capturing a current GPS parameter of the first user device, and/or determining a location of the first user device based on triangulation of current cellular telephone network associated with the first user device.

17. The apparatus of claim 1, wherein executing the computer-readable program code is configured to further cause the at least one processing device to:
present a navigation interface structured to route an object owner from a current location of the owner device to a location associated with the captured geolocation parameter associated with the first user device.

18. The apparatus of claim 1, wherein establishing the secure operative communication between the owner device associated with the object entity and the first user device without transmission of identifier parameters associated with at least the owner device associated with the object entity, comprises establishing secure operative communication between the owner device associated with the object entity such (i) an object owner associated with the owner device and/or a user associated with the first user device are anonymous, and/or (ii) the user associated with the first user device cannot view contact information associated with the object owner.

19. The apparatus of claim 1, wherein the first identification code associated with the object tag is associated with a microchip implanted into the object entity.

20. The apparatus of claim 1, wherein executing the computer-readable program code is configured to further cause the at least one processing device to:
provide an object entity identification database having one or more object entity records stored therein, wherein each of the one or more object entity records are associated with an object entity;
provide the first identification code such that the first identification code is associated with the object tag and the object entity; and
create a first object entity record of the one or more object entity records, wherein the first object entity record is associated with the first identification code, the object tag, the object entity, and/or identifier parameters associated with the owner device.

21-41. (canceled)

42. A computer program product for multi-channel communication based real-time geolocation of an object entity, wherein the computer program product is configured for dynamic location of an object and real-time notification transmission to an object owner, the computer program product comprising a non-transitory computer-readable storage medium having computer-executable instructions to:
receive a first communication message associated with a first identification code from a first user device, wherein the first identification code is associated with an object tag component, wherein the object tag is structured to be coupled with an associated object entity;
determine the object entity associated with the first identification code and the object tag component, based on analyzing the first communication message;
in response to the first communication message, trigger transmission of a first response message to the first user device, in real-time, wherein the first response message comprises a user action component;
in response to activation of the user action component of the first response message at the first user device, trigger a display overlay of an object attribute interface at a display device of the first user device, wherein the object attribute interface comprises a secure communication trigger action component structured for establishing operative communication between an owner device associated with the object entity and the first user device; and
in response to determining activation of the secure communication trigger action component of the object attribute interface at the first user device:
capture a geolocation parameter associated with the first user device;
construct an object location interface associated with the determined object entity, wherein the object attribute interface comprises a location display component associated with the captured geolocation parameter associated with the first user device; and
initiate presentation of the object location interface at the owner device associated with the object entity.

43-45. (canceled)

46. The computer program product of claim 42, wherein the object tag comprises a scannable element displayed on a first surface, wherein the scannable element is associated with the first identification code, wherein the object tag is structured such that scanning the scannable element via the first user device is structured to initiate construction of the first communication message at a first communication channel application interface of the first user device, wherein constructing the first communication message comprises:
adding text associated with the first identification code in a body of the first communication message; and/or
adding a contact identifier parameter associated with an object entity identification database at a recipient field associated with the communication message, wherein the contact identifier parameter comprises a telephone number.

47-61. (canceled)

62. A method for multi-channel communication based real-time geolocation of an object entity, wherein the method is structured for dynamic location of an object and real-time notification transmission to an object owner, the method comprising:
receiving a first communication message associated with a first identification code from a first user device, wherein the first identification code is associated with an object tag component, wherein the object tag is structured to be coupled with an associated object entity;
determining the object entity associated with the first identification code and the object tag component, based on analyzing the first communication message;
in response to the first communication message, triggering transmission of a first response message to the first user device, in real-time, wherein the first response message comprises a user action component;
in response to activation of the user action component of the first response message at the first user device, triggering a display overlay of an object attribute interface at a display device of the first user device, wherein the object attribute interface comprises a secure communication trigger action component structured for establishing operative communication between an owner device associated with the object entity and the first user device; and
in response to determining activation of the secure communication trigger action component of the object attribute interface at the first user device:
capturing a geolocation parameter associated with the first user device;
constructing an object location interface associated with the determined object entity, wherein the object attribute interface comprises a location display component associated with the captured geolocation parameter associated with the first user device; and
initiating presentation of the object location interface at the owner device associated with the object entity.

63-65. (canceled)

66. The method of claim 62, wherein the object tag comprises a scannable element displayed on a first surface, wherein the scannable element is associated with the first identification code, wherein the object tag is structured such that scanning the scannable element via the first user device is structured to initiate construction of the first communication message at a first communication channel application interface of the first user device, wherein constructing the first communication message comprises:
adding text associated with the first identification code in a body of the first communication message; and/or
adding a contact identifier parameter associated with an object entity identification database at a recipient field associated with the communication message, wherein the contact identifier parameter comprises a telephone number.

67-81. (canceled)
